(19) United States
(12) Patent Application Publication
(10) Pub. No.: US 2025/0071767 A1
(43) Pub. Date: Feb. 27, 2025

(54) Multi-Slot PDCCH Monitoring With Slot Groups

(71) Applicant: Apple Inc., CUPERTINO, CA (US)

(72) Inventors: Oghenekome OTERI, San Diego, CA (US); Chunxuan YE, San Diego, CA (US); Chunhai YAO, Beijing (CN); Dawei ZHANG, Saratoga, CA (US); Haitong SUN, Saratoga, CA (US); Hong HE, San Jose, CA (US); Huaning NIU, San Jose, CA (US); Seyed Ali Akbar FAKOORIAN, San Diego, CA (US); Sigen YE, San Diego, CA (US); Wei ZENG, Saratoga, CA (US); Weidong YANG, San Diego, CA (US); Yushu ZHANG, Beijing (CN)

(21) Appl. No.: 18/703,005

(22) PCT Filed: Nov. 5, 2021
(86) PCT No.: PCT/CN2021/129137

§ 371 Date: Apr. 19, 2024

(51) Int. Cl. H04W 72/23; H04B 7/06; H04W 72/0446

(52) U.S. Cl. CPC H04W 72/23; H04B 7/0626; H04W 72/0446

(57) ABSTRACT

A user equipment (UE) is configured to configure a first search space (SS) set of a first slot group for multi-slot physical downlink control channel (PDCCH) monitoring (MSM), configure a second SS set of a second slot group for MSM, receive an indication of a beam change in a control resource set (CORESET), configure an updated first SS set of the first slot group for MSM, configure an updated second SS set of the second slot group for MSM and perform MSM using the updated first SS set and the updated second SS set.

### BACKGROUND

In a Fifth Generation (5G) New Radio (NR) network, for communication above 52.6 Giga hertz (GHz), the subcarrier spacing (SCS) may be increased to provide robustness to phase noise. For example, the SCS may be set to 120 kilo hertz (KHz), 480 KHz or 960 KHz. However, increasing the SCS may result in a reduction in the duration of the symbol which may place an unreasonable strain on user equipment (UE) processing resources during physical downlink control channel (PDCCH) monitoring. Accordingly, there is a need to improve the efficiency of PDDCH monitoring for communication above 52.6 GHZ.

### SUMMARY

Some exemplary embodiments are related to a processor of a user equipment (UE) configured to perform operations. The operations include configuring a first search space (SS) set of a first slot group for multi-slot physical downlink control channel (PDCCH) monitoring (MSM), configuring a second SS set of a second slot group for MSM, receiving an indication of a beam change in a control resource set (CORESET), configuring an updated first SS set of the first slot group for MSM, configuring an updated second SS set of the second slot group for MSM and performing MSM using the updated first SS set and the updated second SS set.

Other exemplary embodiments are related to a processor of a base station configured to perform operations. The operations include transmitting multi-slot physical downlink control channel (PDCCH) monitoring (MSM) parameters to a user equipment (UE), wherein the UE utilizes multiple slot groups to perform MSM and transmitting information to the UE on the PDCCH. The exemplary embodiments further include the multiple slot groups including a first slot group corresponding to a first search space (SS) set comprising at least one of a type 1 common search space (CSS) with a dedicated radio resource control (RRC) configuration, a type 3 CC and a UE specific SS. The exemplary embodiments further include the multiple slot groups including a second slot group corresponding to a second SS set comprising at least one of a type 1 common search space (CSS) without a dedicated radio resource control (RRC) configuration, a type 0 CC, a type 0A CSS and a type 2 CSS.

### BRIEF DESCRIPTION OF THE DRAWINGS

FIG. 1 shows an exemplary set of slot groups within a subframe according to various exemplary embodiments.

FIG. 2 shows an example arrangement of Group 1 and Group 2 according to various exemplary embodiments.

FIG. 3 shows a method for multi-slot physical downlink control channel (PDCCH) monitoring (MSM) according to various exemplary embodiments.

FIG. 4 shows a signaling diagram for providing MSM parameters to the UE according to various exemplary embodiments.

FIG. 5 shows a signaling diagram for providing MSM parameters to the UE according to various exemplary embodiments.

FIG. 6 shows an example medium access control (MAC) control element (CE) according to various exemplary embodiments.

FIG. 7 shows an example MAC CE according to various exemplary embodiments.

FIG. 8 shows an example of identifying a time offset parameter (n0) for Group 1 search space (SS) set according to various exemplary embodiments.

FIG. 9 shows an example of slot group locations in a carrier aggregation (CA) scenario where the component carriers (CCs) are configured with a same subcarrier spacing (SCS).

FIG. 10 shows an example of slot group locations in a CA scenario where the CCs are configured with a different SCS.

FIG. 11 shows an example of slot group locations in a CA scenario where the CCs are configured with a different SCS.

FIG. 12 shows an exemplary network arrangement according to various exemplary embodiments.

FIG. 13 shows an exemplary user equipment (UE) according to various exemplary embodiments.

FIG. 14 shows an exemplary base station according to various exemplary embodiments.

### DETAILED DESCRIPTION

The exemplary embodiments may be further understood with reference to the following description and the related appended drawings, wherein like elements are provided with the same reference numerals. The exemplary embodiments introduce techniques for multi-slot physical downlink control channel (PDCCH) monitoring.

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

In a Fifth Generation (5G) New Radio (NR) network, for communication above 52.6 Giga hertz (GHz), the subcarrier spacing (SCS) may be increased to provide robustness to phase noise. For example, the SCS may be set to 120 kilo hertz (KHz), 480 KHz or 960 KHz. However, increasing the SCS may result in a reduction in the duration of the symbol. From the perspective of the UE, the reduction in symbol duration may increase the number of operations that are to be performed by the UE for PDCCH monitoring which may place an unreasonable strain on UE processing resources.

It has been identified that it may be beneficial to utilize multi-slot PDCCH monitoring (MSM) for communication above 52.6 GHz. MSM may allow the UE to avoid the processing strain associated with other PDDCH monitoring approaches. However, while the exemplary techniques described herein may provide benefits to 5G NR communication above 52.6 GHZ, the exemplary embodiments are not limited to this frequency range.

MSM may generally refer to a PDCCH monitoring approach that is based on slot groups that each comprise (X) consecutive slots. As will be described in more detail below, for MSM, the UE may perform PDCCH monitoring during (Y) slots of each slot group. To provide a general example, if a slot group comprises (X=4) consecutive slots and (Y=1) slot, the UE may perform PDCCH monitoring in 1 slot out of the 4 consecutive slots.

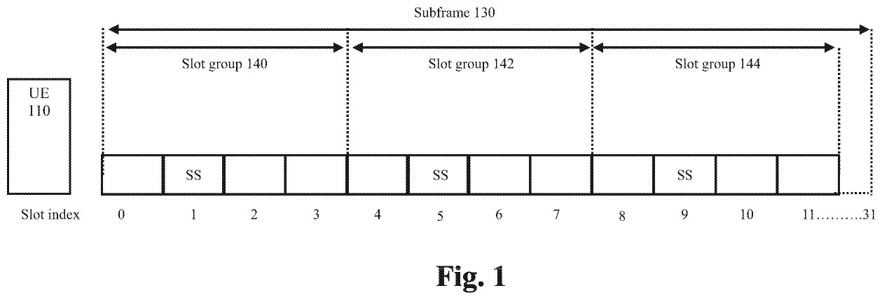

FIG. 1 shows an exemplary set of slot groups 140-144 within a subframe 130 according to various exemplary embodiments. This exemplary slot group arrangement is not intended to limit the exemplary embodiments in any way and is merely provided as a general overview of the relationship between a slot group and a subframe. A subframe may comprise 1 slot or multiple slots (e.g., 2, 4, 5, 12, 16, etc.) and the exemplary embodiments are not limited to any particular number of slots or slot groups per subframe.

The UE 110 may be configured with a PDCCH that includes multiple subframes 130. In this example, the PDCCH may be configured with a SCS of 480 KHz and 32 slots per subframe. FIG. 1 shows a portion of a subframe 130 with 12 slots indexed 0-11. This portion of subframe 130 is arranged into 3 separate slot groups 140-144 and each slot group 140-144 comprises X=4 slots. There are 32 slots per subframe in this example and thus, the remaining portion of subframe 130 that is not pictured in FIG. 1 may include 20 slots indexed 12-31. The slots indexed 12-31 may be arranged into 5 separate groups each comprising X=4 slots. Therefore, while only 3 slot groups 140-144 are shown in FIG. 1, subframe 130 may include a total 8 slot groups with a slot group size of X=4 slots across its 32 slots.

In this example, the UE 110 may be configured to perform PDCCH monitoring in 1 slot from each of the slot groups 140-144 (e.g., Y=1). Thus, in a first slot group 140 comprising slots indexed 0-3, the UE 110 may have a PDCCH SS during slot 1. During slots indexed 0, 2 and 3, the UE 110 has the opportunity to sleep and conserve power since the UE 110 is not configured to perform PDCCH monitoring during the other slots 0, 2, 3. In a second slot group 142 comprising slots indexed 4-7, the UE 110 may have a PDCCH SS during slot 5. During slots indexed 4, 6 and 7, the UE 110 has the opportunity to sleep and conserve power since the UE 110 is not configured to perform PDCCH monitoring during the other slots 4, 6, 7. In a third slot group 144 comprising slots indexed 8-11, the UE 110 may have a PDCCH SS during slot 9. During slots indexed 8, 10 and 11, the UE 110 has the opportunity to sleep and conserve power since the UE 110 is not configured to perform PDCCH monitoring during the other slots 8, 10, 11. The UE 110 may behave in the same manner on the other 5 slot groups referenced above in the remaining portion of subframe 130 that is not pictured in FIG. 1.

Slot groups may be consecutive to one another and not overlap in time. Thus, in this example, slot group 140 comprises slots indexed 0-3, slot group 142 comprises slots indexed 4-7 and slot group 144 comprises slots indexed 8-11. The start of a first slot group in a subframe (e.g., slot group 140) may be aligned with a slot boundary (e.g., slot index 0 (not pictured)). The start of each slot group may be aligned with a slot boundary. In this example, there is no gap between the slot groups 140-144. FIG. 1 is not intended to limit the exemplary embodiments in any way and is merely provided as a general overview of the relationship between a slot group and a subframe. The exemplary embodiments may apply to any appropriate SCS, subframe duration, number of slots per subframe, number of slot groups, slot group size, etc.

As will be described in more detail below, a control resources set (CORESET) may be defined and based on the CORESET a search space (SS) may be defined. The UE 110 may perform PDCCH monitoring within the SS. The following examples provide a general overview of SSs within the slot group framework.

Throughout this description, reference is made to “Group 1” to identify a first set of consecutive slot groups each comprising (X) consecutive slots and “Group 2” to identify a second set of consecutive slot groups each comprising (B) consecutive slots. However, it should be noted that the terms “Group 1” and “Group 2” do not confer any special meaning to the slot groups. These terms are merely used to distinguish between two different slot groups. In some exemplary embodiments, the Group (1) SS includes a Type 1 CSS with dedicated RRC configuration and type 3 CSS, with UE specific SS. The RRC configuration may occur every slot/multi-slot. In addition, in some exemplary embodiments, Group (2) SS includes Type 1 CSS without dedicated RRC configuration and type 0, 0A, and 2 CSS. This may be configured before RRC configuration and typically, does not occur as often, e.g., Type 0 may occur once every 20 msec, Type 2 (paging) occurs in idle mode. However, this is only an example and the “Group 1” and “Group 2” slot groups are, as described above, not limited to any particular type of slot groups.

The slot group size (X) for Group 1 may be the same as or different than the slot group size (B) for Group 2. Group 1 and Group 2 may be each be associated with the same or different frequency resources and overlap (fully or partially) in the time domain. The examples provided below mention Group 1 specific parameters (e.g., slot group size X and PDCCH span Y) and Group 2 specific parameters (e.g., slot group size B and PDCCH span A). In some embodiments, the Group 1 specific parameters and the Group 2 specific parameters may be the same value. In this type of configuration, a single parameter may be used to represent both the slot group size for Group 1 and the slot group size for Group 2. Similarly, in this type of scenario, a single parameter may be used for both the PDCCH monitoring span for Group 1 and the PDCCH monitoring span for Group 2. For example, instead of utilizing/signaling an X and B parameter the network and/or the UE 110 may utilize X for both Group 1 and Group 2. Instead, of utilizing/signaling a Y and A parameter the network and/or the UE 110 may utilize Y for both Group 1 and Group 2. In some embodiments, the Group 1 specific parameters and the Group 2 specific parameters may be the same value for some parameters and different values for others. In this type of configuration, a single parameter may be used to represent both the slot group size for Group 1 and the slot group size for Group 2. Separate parameters may be used for the PDCCH monitoring span for Group 1 and the PDCCH monitoring span for Group 2. For example, instead of utilizing/signaling an X and B parameter the network and/or the UE 110 may utilize X for both Group 1 and Group 2. We then utilize/signal a Y and A parameter from the network and/or the UE 110 may utilize Y for Group 1 and A for Group 2.

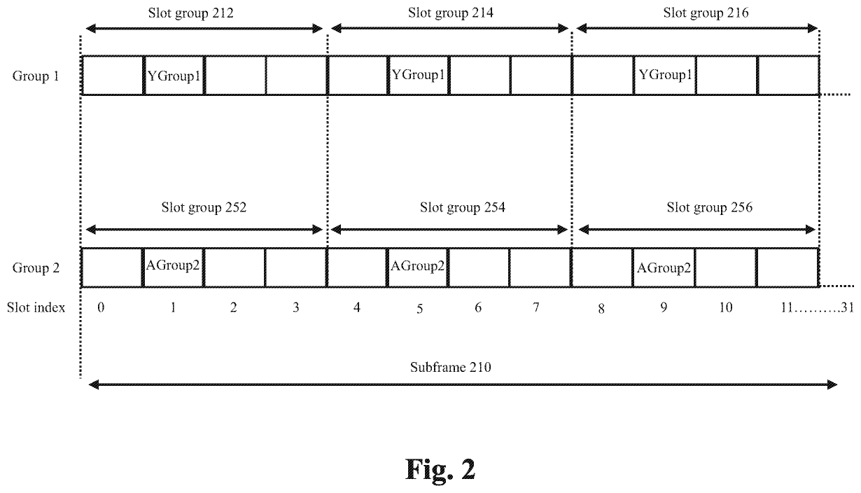

FIG. 2 shows an example arrangement of Group 1 and Group 2 according to various exemplary embodiments. FIG. 2 includes a portion of a subframe 210 with slots indexed 0-11. Group 1 and Group 2 are be located on a same or different frequency domain and may overlap in the time domain. This arrangement of Group 1 and Group 2 is not intended to limit the exemplary embodiments in any way and is merely provided as a general overview of the relationship between a Group 1 and Group 2.

In this example, Group 1 is configured with slot groups 212-216 that comprise (X=4) slots. Thus, in this example, slot group 212 includes slots indexed 0-3, slot group 214 includes slots indexed 4-7 and slot group 216 includes slots indexed 8-11. The arrangement of slot groups in this example may be similar to the example provided in FIG. 1 with regard to subframe 130.

Similarly, Group 2 is also configured with slot groups 252-256 that comprise (B=4) slots. Thus, slot group 252 includes slots indexed 0-3, slot group 254 includes slots indexed 4-7 and slot group 256 includes slots indexed 8-11. In this example, the arrangement of slot groups in Group 1 and Group 2 are the same.

In FIG. 2, the depicted arrangement of Group 1 and Group 2 is not intended to limit the exemplary embodiments in any way and is merely provided as a general overview of the relationship between a Group 1 and Group 2. The exemplary embodiments may apply to any appropriate SCS, subframe duration, number of slots per subframe, number of slot groups, slot group size, etc. Additional information regarding the relationship between Group 1 and Group 2 will be provided below.

A Group 1 SS may be configured within (Y) consecutive slots of a slot group with a slot group size of (X) consecutive slots. Similarly, a Group 2 SS may be configured within (A) consecutive slots of a slot group with a slot group size of (B) consecutive slots. To differentiate between the SS slots for Group 1 and the SS slots for Group 2, reference may be made to “YGroup1” representing the (Y) consecutive slots of Group1 and “AGroup2” representing the (A) consecutive slots of Group2. In various examples below, YGroup1 and AGroup2 are the same value. However, the exemplary embodiments are not limited to a scenario where YGroup1 and AGroup2 are the same and may apply to YGroup1 and AGroup2 being any appropriate value.

To provide an example within the context of FIG. 2, YGroup1 may be set to 1 slot and be configured to occur every second slot of each slot group 212-216. Thus, the UE 110 may perform PDCCH monitoring for Group 1 during one or more symbols of slot index 1, slot index 5 and slot index 8. AGroup2 may also be set to 1 slot and be configured to occur every second slot of each slot group 252-256. Thus, the UE 110 may perform PDCCH monitoring for Group 2 during one or more symbols of slot index 1, slot index 5 and slot index 8.

As will be explained in more detail below, the location of YGroup1 within a slot group may be based on a time offset and the time offset may be based on a slot index “n0” determined for Group2 monitoring such that the YGroup1 slots overlap in time with the AGroup2 slots. For instance, continuing with the example shown in FIG. 2, each instance of AGroup1 may overlap in time with each instance of AGroup2. However, while it may be beneficial for AGroup1 and AGroup2 to overlap in time from a PDCCH processing perspective, MSM does not require that Group 1 SS and the Group 2 SS overlap in time (e.g., “n0” for Group 1 may be different than the “n0” for Group 2.

The UE 110 may be configured with a blind decoding (BD)/control channel element (CCE) budget indicating the number of blind decodes and the CCE size supported by the UE 110 within Y or A=max(YGroup1, AGroup2) per slot group. In some embodiments, the UE 110 may be required to report the BD/CCE budget for one or more slot group sizes if the UE 110 supports a SCS associated with a particular slot group size (e.g., 120 KHz, 480 KHz, 960 KHz, etc.). In other embodiments, the UE 110 may not be required to report a BD/CCE budget for a slot group size even if the UE 110 supports the corresponding SCS. In some embodiments, the BD/CCE budget may be hard encoded in 3GPP Specifications or predetermined in any other appropriate manner. During operation, when the UE 110 the BD/CCE budget may be known based on the (X, B) (Y, A) values. For MSM, there may be a common BD/CCE budget for all SSs.

The location of YGroup1 within a slot group may be maintained across different slot groups unless the parameter “n0” changes. BD attempts for all Group 1 SSs may fall within the same YGroup1 slots.

The location of the AGroup2 within a slot group is maintained across different slot groups unless the parameter “n0” changes. The reported capability indicates the BD/CCE budget within Y or A=max(YGroup1, AGroup2) slots per slot group. To provide some example configurations, when (X) and (B) are both equal to 8 slots, YGroup1 may be equal to 4, 2 or 1 and AGroup2 may be equal to 2 or 1. Thus, X or B=8:(YGroup1, AGroup2)=(4,2), (2,2), (1, [1 or 2]). When (X) and (B) are both equal to 4 slots, YGroup1 may be equal to 2 or 1 and AGroup2 may be equal to 2 or 1. Thus, X or B=4:(YGroup1, AGroup2)=(2,2),(1, [1 or 2]). When (X) and (B) are both equal to 2 slots, YGroup1 may be equal to 1 and AGroup2 may be equal to 2 or 1. Thus, X or B=8:(YGroup1, AGroup2)=(1, [1 or 2]).

Group 1 may support a type 1 common search space (CSS) with dedicated radio resource control (RRC) configuration, a type 3 CSS and/or a UE specific SS. Those skilled in the art will understand that for the above referenced types of SSs, the monitoring occasion may be configured within the first 3 orthogonal frequency division multiplexing (OFDM) symbols of a slot (e.g., Rel-17) or within a span comprised of appropriate number of OFDM symbols (N) located anywhere within the slot. Thus, a Group 1 SS may refer to a type 1 CSS with dedicated RRC configuration, a type 3 CSS and/or a UE specific SS. As indicated above, these one or more Group 1 SS types may be configured to fall within YGroup1.

Group 2 may support a type 1 CSS without dedicated RRC configuration, a type 0 CSS, a type 0A CSS and/or a type 2 CSS. Those skilled in the art will understand that for the above referenced types of SSs, the monitoring occasion may be any OFDM symbol of a slot within a span of 3 consecutive OFDM symbols or within a span comprised of any appropriate number of OFMD symbols (e.g., N). Thus, a Group 2 SS may refer to a type 1 CSS without dedicated RRC configuration, a type 0 CSS, a type 0A CSS and/or a type 2 CSS.

Those skilled in the art will also understand that type 1 CSS corresponds to random access, type 0 CSS corresponds to initial access, type 0A CSS corresponds to other system information (OSI) and type 2 CSS corresponds to paging. The location of these types of SSs may correlate to the synchronization signal block (SSB) and thus, the symbol location of the Group 2 SSs may be more complex to control compared to the Group 1 SSs. As will be described in more detail below, the location of Group 1 SS (e.g., YGroup1) may be based on the location of the Group 2 SS (e.g., AGroup2).

The exemplary embodiments are also described with regard to a CORESET. Those skilled in the art will understand that a CORESET may define resource blocks and a number of symbols available to a PDCCH SS set. Thus, a SS set may be mapped to a specific CORESET.

The CORESET may comprise parameters such as, but not limited to, frequency domain resources, a duration (e.g., a number of orthogonal frequency division multiplexing (OFDM) symbols) and a transmission configuration indicator (TCI) state. The TCI state may indicate that a beam is quasi co-located (QCL) to a specific SSB and define a CSS. Thus, the TCI state may indicate the location of one or more SSs relative to the SSB. As will be described in more detail below, the CORESET and its corresponding parameters may be used to configure MSM at the UE 110.

If there is a single TCI state in the CORESET parameter structure, then the UE 110 may assume QCL between PDCCH and SSB/channel state information (CSI)-reference signal (RS) as indicated by the TCI state. In some embodiments, there may be multiple TCI states listed. In this type of scenario, the UE 110 may utilize an activation command to identify the TCI state to apply using TCI state indication for a UE specific PDCCH medium access control (MAC) control element (CE). If the UE 110 has not yet received the MAC CE, the UE 110 may assume a QCL between PDCCH and SSB that was selected during the initial access procedure.

The exemplary embodiments are also described with regard to a SS set. The SS set may use the CORESET to define specific resource blocks and symbols where the UE 110 may attempt to decode PDCCH. The SS set may be based on parameters such as, but not limited to, a CORESET ID, a PDCCH monitoring slot periodicity and offset parameter with reference to a slot with a frame a duration (e.g., a number of slots) over which the SS is valid and a monitoring symbols within a slot parameter. As will be described in more detail below, the SS set and its corresponding parameters may be used to configure MSM at the UE 110.

The exemplary embodiments introduce techniques for implementing MSM. In one aspect, the exemplary embodiments relate to MSM parameter signaling. In another aspect, the exemplary embodiments relate to the initial configuration of Group 1 SS. In a further aspect, the exemplary embodiments relate to Group 1 SS set beam adaptation and Group 2 SS set beam adaption. In another aspect, the exemplary embodiments relate to slot group alignment for carrier aggregation (CA) scenarios. Each of these exemplary aspects will be described in more detail below. Each of the exemplary techniques described herein may be used independently from one another, in conjunction with currently implemented MSM techniques, in conjunction with future implementations of MSM techniques or independently from other MSM techniques.

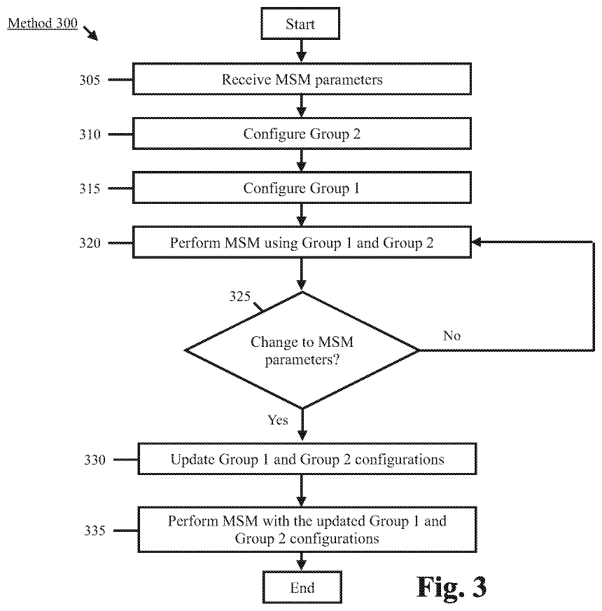

FIG. 3 shows a method 300 for MSM according to various exemplary embodiments. The method 300 is described from the perspective of a UE 110 and provides a general overview of MSM. The method 300 is not intended to limit the exemplary embodiments in any way. Instead, the method 300 is intended to illustrate one example of how the exemplary aspects referenced above may relate to one another when the UE 110 is deployed.

In 305, the UE 110 receives MSM parameters. Generally, the MSM parameters may enable the UE 110 to perform MSM. To provide some examples, the MSM parameters may include but are not limited to, a slot group size (e.g., X, B), a time offset (e.g., n0) and a span of PDCCH within a slot group (e.g., Y, A).

In some embodiments, MSM may be activated and deactivated. For example, an MSM state for the UE 110 may be activated and/or deactivated by the network via a MAC CE activation command or any other appropriate signal. Thus, in some embodiments, the UE 110 may transition between an active MSM state where the UE 110 is to perform MSM using particular parameters and an inactive MSM state where the UE 110 may be configured with the MSM parameters but does not actually perform MSM using the corresponding MSM parameters. As will be described in more detail below, the UE 110 may be configured with multiple MSM states and the network may activate an MSM state using a MAC CE activation command.

In 310, the UE 110 configures Group 2. In 315, the UE 110 configures Group 1. The Group 1 SS set and the Group 2 SS set may be configured based on MSM parameters explicitly signaled to the UE 110, implicitly signaled to the UE 110 or preconfigured at the UE 110. In some embodiments, the UE 110 receives a Group 2 and/or Group 2 configuration from the gNB 1220A and then sets the corresponding MSM parameters itself. In other embodiments, the UE 110 configures Group 1 and Group 2 without any explicit instruction from the network.

As indicated above, in some embodiments, the UE 110 may determine the location of a Group 1 SS (e.g., YGroup1) within a slot group based on a time offset (n0) parameter defined relative to the slot group and corresponding to the location of the Group 2 SS within a slot group. To provide an example, the Group 2 SS may be scheduled to occur every second slot of a slot group. Thus, the UE 110 may derive a time offset for Group 2 (e.g., no_grp2) based on the location of AGroup2 within a slot group comprising (B) slots. The time offset for Group 1 (e.g., n0_grp1) may be derived by the UE 110 based the time offset for Group 2. Throughout this description, for some embodiments, “n0” may generally refer to both the time offset for Group 1 (n0_grp1) and the time offset for Group 2 (n0_grp2) since these parameters may be the same.

In 320, the UE 110 performs MSM using Group 1 and the Group 2. In 325, the UE 110 determines whether there is a change to the MSM parameters. For example, the MSM parameters may be changed due to beam management because when a downlink beam for PDCCH is changed, the location of the Group 2 SSs may also change. Since the location of the Group 1 SSs may be based on the location of the Group 2 SSs, a change to the beam may also cause a change to the location of the Group 1 SSs.

If there is a change to the MSM parameters, the method 300 continues to 330. In 330, the UE 110 updates the Group 1 and Group 2 configurations based on the change to the MSM parameters. Examples of updating Group 1 and Group 2 configurations in response to a beam change are provided below after the method 300. In 335, the UE 110 performs MSM using the updated Group 1 and Group 2 configurations.

If there is no change to the MSM parameters, the method 300 returns to 320 where the UE 110 continues to perform MSM using Group 1 and Group 2. The UE 110 may continue to perform MSM until the MSM state is deactivated, the PDCCH is released, or any other appropriate condition occurs.

As mentioned above, in one aspect, the exemplary embodiments relate to MSM parameter signaling. In one approach, MSM parameters may be signaled to the UE 110 within a CORESET.

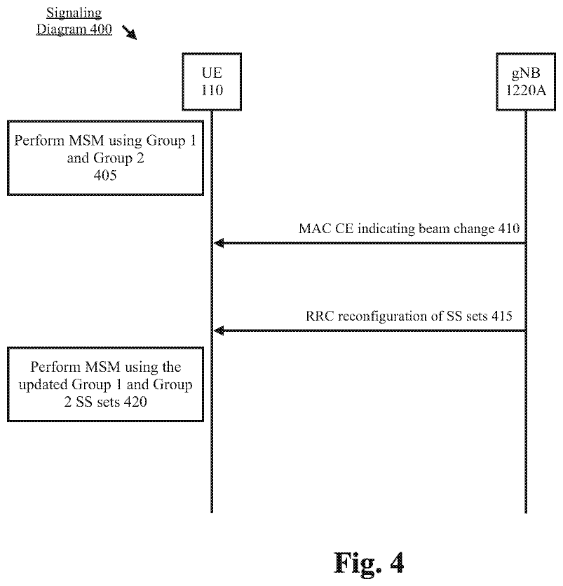

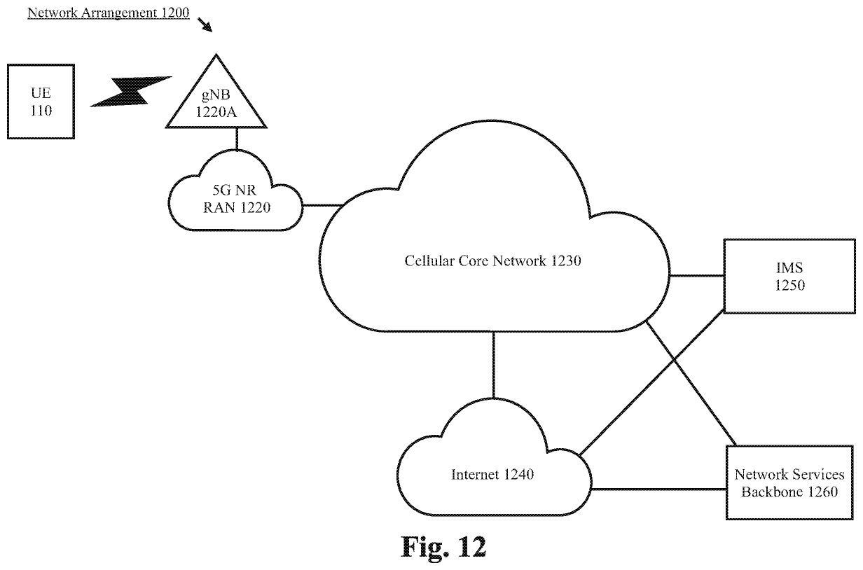

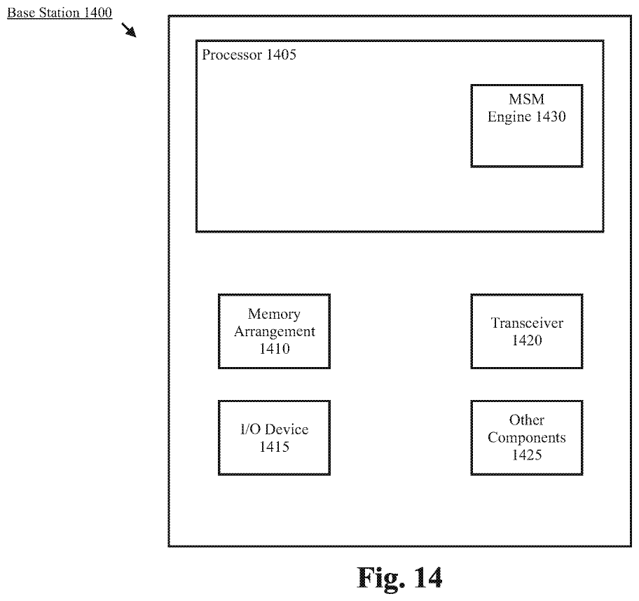

FIG. 4 shows a signaling diagram 400 for providing MSM parameters to the UE 110 according to various exemplary embodiments. The signaling diagram 400 includes the UE 110 and a gNB 1220A. In this example, the gNB 1220A may represent any appropriate type of base station or access node. Additional details for the gNB 1220A can be found below in the network arrangement 1200 of FIG. 12 and the base station 1400 of FIG. 14.

In this example, it is assumed that the UE 110 is already configured with a downlink beam, a Group 1 SS set and a Group 2 SS set. Thus, in 405, the UE 110 performs MSM using Group 1 and Group 2.

In 410, the UE 110 receives a MAC CE indicating a beam change in a CORESET. For example, the MAC CE may indicate to the UE 110 that the gNB 1220A is to change a downlink beam for the CORESET on the PDCCH from a first beam to a second different beam. Those skilled in the art will understand that, in some embodiments, a beam index may be utilized by the UE 110 and/or the network to differentiate between different downlink beams.

In 415, the UE 110 receives one or more RRC messages from the gNB 1220A indicating a reconfiguration of the SS sets associated with the CORESET. The CORESET parameters and/or the one or more RRC messages may explicitly or implicitly indicate to the UE 110 how the location of the SS sets are to be updated in response to the beam change. Thus, the CORESET and/or the RRC messages may be used to reconfigure the timing (e.g., periodicity and offset) of the Group 1 and Group 2 SS sets associated with the CORESET.

In one example, parameters such as a slot group size (e.g., X, B), a span of PDCCH within the slot group (e.g., Y, A), and the time offset (n0) may be explicitly signaled to the UE 110 in the one or more RRC messages.

In another example, a slot group size (e.g., X, B) may be explicitly signaled to the UE 110. Other parameters such as, the span of PDCCH within the slot group (e.g., Y, A) may be implicitly signaled via the CORESET duration (e.g., a number of OFDM symbols) and the time offset (n0) may be implicitly signaled from the TCI state of the CORESET which may be based on an initial access SSB. Those skilled in the art will understand that the initial access SSB may identify the location of type 0 CSS. This may indicate to the UE 110 the updated location of the Group 2 SS set.

For SS types other than type 0 CSS, the SS set may be reconfigured to map to the new CORESET and the new CORESET may indicate the timing information for the other SSs. In this type of scenario, the UE 110 may utilize a legacy periodicity and offset parameter for the SS, change the periodicity and offset for the SS indirectly using integer multiple of a slot group size and a time offset (n0) within the slot group or reconfigure the offset of the SS to match the (n0) parameter.

In a further example, a slot group size (e.g., X, B) and the time offset parameter (n0) may be explicitly signaled to the UE 110 in the one or more RRC messages. The span of PDCCH within the slot group may be implicitly signaled via the CORESET duration (e.g., a number of OFDM symbols).

In 420, the UE 110 may perform MSM using the updated Group 1 and Group 2 SS sets. On the network side, the gNB 1220A may signal control channel information to the UE 110 in a CORESET on the PDCCH at a time and frequency location corresponding to the updated Group 1 and Group 2 SS sets (not pictured).

As mentioned above, the UE 110 may be configured in a MSM state. The MSM state may be signaled to the UE 110 as a separate parameter or may be included in a TCI state. The gNB 1220A may utilize the MAC CE activation command to activate the MSM state at the UE 110.

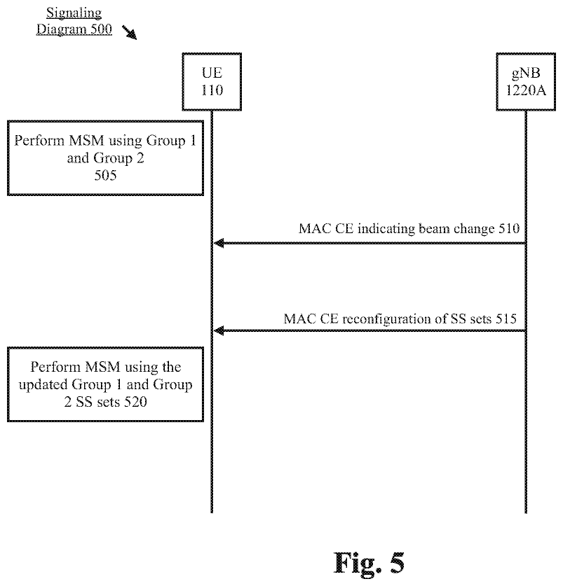

FIG. 5 shows a signaling diagram 500 for providing MSM parameters to the UE 110 according to various exemplary embodiments. The signaling diagram 500 includes the UE 110 and the gNB 1220A.

In this example, it is assumed that the UE 110 was previously configured with a Group 1 and Group 2. Thus, in 505, the UE 110 performs MSM using Group 1 and Group 2.

In 510, the UE 110 receives a MAC CE indicating a beam change in a CORESET. For example, the MAC CE may indicate to the UE 110 that the gNB 1220A is to change a downlink beam for the CORESET on the PDCCH from a first beam to a second different beam. This is similar to 410 of the signaling 400.

In the signaling diagram 500, instead of using RRC signaling to update the periodicity and offset for the SSs, a new MAC CE is introduced. In 515, the UE 110 receives a MAC CE that is configured to update the periodicity and offset of a Group 1 SS set and/or a Group 2 SS set. In some embodiments, there may be multiple MAC CEs, one for each SS or there may be a single MAC CE applicable to all SSs.

In one example, parameters such as a slot group size (e.g., X, B), a span of PDCCH within the slot group (e.g., Y, A), and the time offset (n0) for one or more SS configurations may be explicitly signaled to the UE 110 in the one or more MAC CEs.

In another example, a slot group size (e.g., X, B) may be explicitly signaled to the UE 110 in the MAC CE. Other parameters such as, the span of PDCCH within the slot group (e.g., Y, A) may be implicitly signaled via the CORESET duration (e.g., a number of OFDM symbols) and the time offset (n0) may be implicitly signaled from the TCI state of the CORESET which may be based on an initial access SSB. Those skilled in the art will understand that the initial access SSB may identify the location of type 0 CSS. This may indicate to the UE 110 the updated location of the Group 2 SS set if the Group 2 SS set is a type 0 CSS.

In a further example, a slot group size (e.g., X, B) and the time offset parameter (n0) may be explicitly signaled to the UE 110 in the one or more MAC CEs. The span of PDCCH within the slot group may be implicitly signaled via the CORESET duration (e.g., a number of OFDM symbols).

In 520, the UE 110 may perform MSM using the updated Group 1 and Group 2 SS sets. On the network side, the gNB 1220A may signal control channel information to the UE 110 in a CORESET on the PDCCH at a time and frequency location corresponding to the updated Group 1 and Group 2 SS sets (not pictured).

As mentioned above, the UE 110 may be configured with one or more MSM states. The MSM states may be signaled to the UE 110 as a separate parameter or may be included in a TCI state. The gNB 1220A may utilize the MAC CE activation command to activate the MSM state at the UE 110.

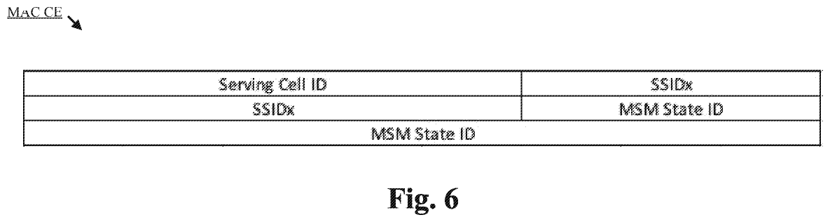

There may be an SS set MAC CE activation that maps to a new CORESET and identifies timing information. In some embodiments, there may be a single MAC CE that indicates timing information for a specific SS set. In another example, a single MAC CE may indicate timing information for a group of SS sets where the group of SS sets are configured into a single SS ID. Thus, the single SS ID may be mapped to multiple SS sets. FIG. 6 shows an example of this type of MAC CE. In this example, the MAC CE field includes a serving cell ID and a SS ID. As mentioned above, the single SS ID may map to multiple SS sets. In addition, the MAC CE field may include an MSM state ID that indicates relevant timing information for the SS set and/or other MSM parameters.

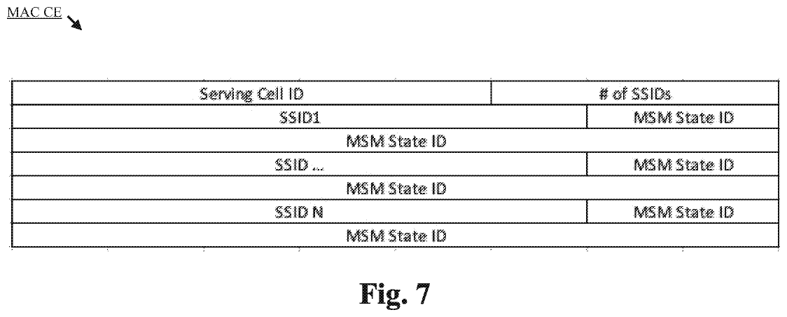

In other embodiments, the MAC CE may configure multiple SS sets. For example, the MAC CE may include a list of SS IDs and their corresponding MSM information. FIG. 7 shows an example, of this type of MAC CE field and includes a serving cell ID and a list of multiple SS IDs (e.g., SSID1-SSID(n)). In addition, a MSM state ID corresponding to each SS ID may indicate relevant timing information for the SS set and/or other MSM parameters for the SS set ID. In a further embodiment, the MSM timing information for one or more SS sets may be combined with the CORESET MAC CE.

In one example, the MSM state information may correspond to a legacy periodicity and offset. In another example, a change in the periodicity and offset of a SS set may be indirectly signaled to the UE 110. Here, the legacy periodicity and offset are integer multiples of the slot group size plus the offset (n0) within a slot group derived from CSS type 0. In another example, the MAC CE may be configured to only change the timing offset of a SS set.

In another approach, the MSM parameters may be provided to the UE 110 using a default configuration. For instance, like in the signaling diagrams 500-600, there may be a beam change in a CORESET using a MAC CE. The default configuration may be then used to update the timing information for the SS set (e.g., periodicity, offset, etc.).

In one example, the default configuration may be that the updated SS set configuration becomes identical to the CSS type 0 configuration. In another example, the default configuration may be that the SS set configuration is based on a legacy configuration plus the timing offset parameter (n0). Here, the legacy monitoring periodicity and offset maps to a beginning of a slot group and the UE 110 may add the time offset (n0) based on CSS type 0 configuration.

In a further approach, the MSM parameters may be signaled to the UE 110 using a combination of RRC messages, a MAC CE and downlink control information (DCI). To provide an example, in Third Generation Partnership Program (3GPP) release 17 (Rel-17), a TCI state may be modified by the MAC CE and the DCI. Thus, a beam change in the CORESET may be signaled by the network using DCI. Then for each SS, the DCI may be utilized to update the periodicity and offset. This is similar to the example shown in the signaling diagram 500 but instead of a MAC CE, DCI is used to update the SS configuration. The joint TCI state framework in Rel-17 may be leveraged to update the SS set configuration for MSM. In this example, one or more RRC messages may be used by the network to configure a pool of available TCI/MSM states at the UE 110 (e.g., 64 TCI/MSM states or any appropriate number). Next, the network may use a MAC CE to activate a subset of the TCI/MSM states at the UE 110 (e.g., 8 TCI/MSM states or any appropriate number). The network may then use DCI to indicate which of the activated TCI/MSM states are to be used to configure the SS sets.

In another aspect, the exemplary embodiments relate to a UE procedure for the initial identification of the time offset (n0) for the Group 1 SS set. Two approaches are described below, a first approach relates to identifying YGroup1 based on a AGroup2 configuration. A second approach relates to identifying YGroup1 based on explicit signaling.

In one approach, the UE 110 may identify Group 2 SS parameters from a AGroup2 configuration and convert the AGroup2 offset to a MSM offset parameter (n0_grp2). The UE 110 may then set a n0_grp1 parameter from the n0 grp2 parameter.

In one example, for CSS type 0, the UE 110 may receive an offset parameter (“0”) that specifies a slot relative to the start of a frame in which the first of the two CORESET SSs are located and a “First Symbol Index” parameter which identifies the location of the start symbol within the slot in the physical broadcast channel (PBCH). These parameters may be mapped to a table hard encoded in 3GPP Specifications which may enable the UE 110 to determine the AGroup2 configuration. As indicated above, the UE 110 may then convert the AGroup2 offset to a MSM offset parameter (n0_grp2) and set the n0_grp1 parameter from the n0_grp2 parameter.

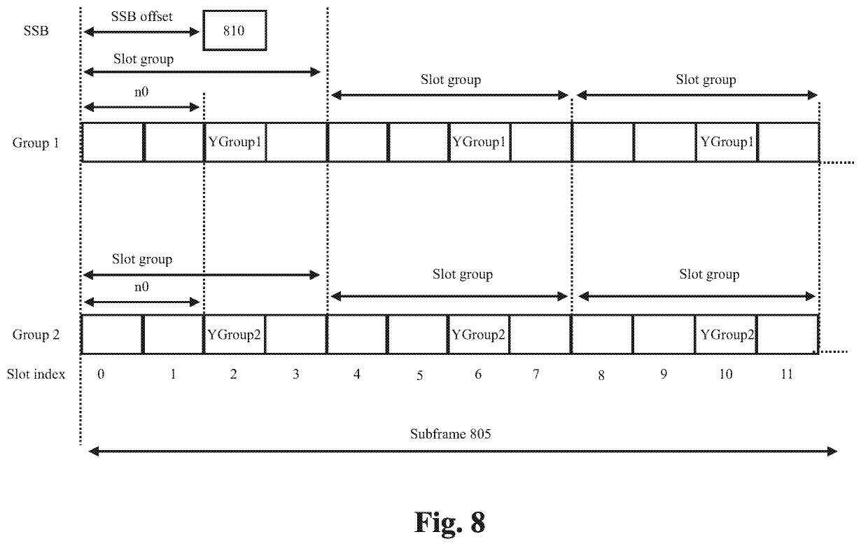

The UE 110 may identify the start of the slot group (B) which contains the Group 2 SS based on the value of (A) and the location of the slot group relative to the subframe boundary. An example of identifying a time offset parameter (n0) for a Group 1 SS is shown in FIG. 8. FIG. 8 includes a portion of a subframe 805 with slots indexed 0-11 and assumes a slot group size (X=4) slots and a slot group size (B=4) slots. The start of the Group 1 slot group and the Group 2 slot group are aligned with the subframe 805 boundary (e.g., slot index 0). The subsequent slot groups are then identified based on the slot group size.

The UE 110 also identifies the location of a SSB 810 (e.g., SSB offset). Since certain types of SSs correspond to the location of the SSB, the UE 110 identify the offset parameter (n0) relative to the slot group size based on the subframe 805 boundary, the SSB offset and the slot group size. As described above, the no may indicate the location of the one or more slots where PDCCH monitoring is to be performed (e.g., YGroup1, AGroup2). The location of the YGroup1 within a slot group may be maintained across different slot groups unless the parameter “n0” changes. Similarly, the location of the AGroup2 within a slot group may be maintained across different slot groups unless the parameter “n0” changes. Thus, in this example, each subsequent slot group includes a YGroup1 and AGroup2 at the same location within the slot group.

For initial access, the slot group size (e.g., X, B) may be set to a default value depending on the SCS (e.g., 4 for 480 KHz, 8 for 960 KHz, or any other appropriate value). Alternatively, for initial access, the value of the slot group size (e.g., X, B) may be signaled in PBCH. In other embodiments, the slot group size (e.g., X, B) may be defined via RRC configuration.

The UE 110 may then estimate n0_grp1 for the Group 1 SS based on the position of the Group 2 SS within (B). As indicated above with respect to FIG. 2, YGroup1 and AGroup2 may overlap in time. The UE 110 may set n0_grp1 based on n0_grp2.

In another embodiment, the UE 110 may receive a Group 1 SS n0_differential parameter from the network (e.g., gNB 1220A). The UE 110 may then estimate n0_grp1 from n0_grp2 and the no differential.

As indicated above, n0_grp1 may be the same n0_grp2 so YGroup1 and AGroup2 overlap in time. To provide an example, consider a scenario where X and B=8: (YGroup1, AGroup2)=(4, 2). Each slot group is 8 slots long, the Group 1 SS is 4 slots long and the Group 2 SS is 2 slots long. The first two slots of the Group 1 SS may overlap in time with the two slots of the Group 2 SS.

In other embodiments, n0_grp1 may be equal to n0_grp2 plus/minus an offset such that YGroup1 and AGroup2 overlap at the end. To provide an example, consider a scenario where X and B=8: (YGroup1, AGroup2)=(4, 2). In other words, each slot group is 8 slots long, the Group 1 SS is 4 slots long and the Group 2 SS is 2 slots long. The last two slots of the Group 1 SS may overlap in time with the two slots of the Group 2 SS.

In another approach, the UE 110 may identify YGroup1 based on explicit signaling. The value of no may be indicated by a Search Space Configuration Table for initial access or by an RRC message that indicated the slot group size (e.g., X, B). In one example, a single value of the time offset no may be signaled for both YGroup1 and AGroup2. In another example, separate time offset no values are signaled for both YGroup1 and AGroup2. In a further example, a single time offset n0 may be signaled for YGroup1 and the time offset for AGroup2 may be derived by the UE 110.

In a further aspect, the exemplary embodiments relate to Group 1 SS set beam adaptation. As will be described in more detail below, the exemplary embodiments introduce techniques that enable the network and the UE 110 to change the Group 1 SS set configuration when there is a change of beam due to beam management. In one approach, the change in the configuration of the Group 1 and Group 2 SS sets may occur in a particular order. First, the UE 110 receives signaling indicating a change in SSB or the location of the Group 2 SS set (e.g., AGroup2). Second, the UE 110 identifies and/or receives signaling to determine the location of the Group 1 SS set (e.g., YGroup1).

In another approach, the change in the configuration of the Group 1 and Group 2 SS sets may occur at approximately the same time and in no particular order. For example, the UE 110 may receive a set of one or more signals indicating both a change in i) SSB and/or Group 2 SS set location and ii) Group 1 SS set location. These changes may be executed by the UE 110 in a simultaneous manner. Additional details for Group 1 SS set beam adaptation using either approach are provided below.

The exemplary techniques for Group 1 SS set beam adaptation are described with regard to a scenario in which Group 2 SS set configuration changes without an initial access procedure (e.g., due to a beam change based on UE mobility, etc.). Some of these exemplary techniques may be used in conjunction with and/or reference the MSM parameter signaling techniques described above with regard to a beam change.

In one technique for Group 1 SS set beam adaptation, the UE 110 may expect an RRC configuration update setting the new location and/or MSM parameters for the Group 1 SS set. In one example, the one or more RRC message may be associated with a CORESET reconfiguration and comprise parameters for the location of the Group 1 SS set such as, but not limited to, the slot group size (e.g., X, B) and the time offset (n0). In another example, the one or more RRC messages may be associated with a SS set reconfiguration and comprises parameter such as, but not limited to the time offset (n0).

In another technique for Group 1 SS set beam adaption, the UE 110 may expect DCI to indicate the new position of the Group 1 SS set. In one example, this DCI may be provided in conjunction with an updated 3GPP Release 17 (Rel-17) joint TCI configuration. In another example, a dedicated DCI field may be introduced for this purpose. From the perspective of the UE 110, the new location Group 1 SS set may be valid immediately after the DCI is decoded or the UE 110 may have to send an acknowledgement (ACK) to the base station before the new location of the Group 1 SS set may be considered valid.

In one technique for Group 1 SS set beam adaptation, the UE 110 may expect a MAC CE activation command to indicate the new location of the Group 1 SS set. In one example, this MAC CE activation command may be provided in conjunction with updating a TCI state configuration. In another example, this MAC CE activation command may be provided in conjunction with a SS set configuration. From the perspective of the UE 110, in one example, the new location of the Group 1 SS set may be considered valid no later than 3 milliseconds (ms) after a hybrid automatic repeat request (HARQ-acknowledgement (ACK) for physical downlink shared channel (PDSCH) that carries a MAC CE. The previous location of the Group 1 SS set may be valid up until the switching point plus 3 ms after the HARQ-ACK is sent to the base station. However, the exemplary embodiments are not limited to this example and the new location of the Group 1 SS set may be considered valid at any appropriate time.

The following description provides additional details for the above referenced example in which the MAC CE activation command indicates the new location of the Group 1 SS using an updated TCI state configuration. In this example, the UE 110 receives an RRC configuration of the TCI indication for Group 1 SS parameters.

In some embodiments, if only a single TCI state is listed within the ControlResourceSet parameter structure, the UE 110 may assume quasi co-location (QCL) between the PDCCH and SSB/channel state information (CSI)-reference signal (RS) specified by the TCI state. Thus, the UE 110 may implicitly determine the timing information or location of the Group 1 SS based on the single TCI state. If there is an association between the TCI state and the SSB, then the time offset for Group 1 (e.g., n0_grp1) may be derived from the time offset for Group 2 (e.g., n0_grp2) of SSB in the TCI state. If there is an association between the TCI state and a channel state information (CSI)-reference signal (RS), then the time offset for Group 1 (e.g., n0_grp1) may be derived from the time offset for Group 2 (e.g., n0_grp2) of SSB QCLed with the CSI-RS. However, if there is no SSB QCLed with CSI-RS then an additional SSB parameter may be added to the TCI state. Alternatively, a default SSB may be configured as the basis for the QCL relationship. For instance, the UE 110 may assume a QCL between the PDCCH and the SSB used to decode the master information block (MIB). In another example, the UE 110 may expect an SSB to be provided as the QCL source for the CSI-RS by the network.

Explicit signaling may also be used. For example, a field value for the time offset (e.g., n0_grp1) may be added to each TCI state. The UE 110 may not expect the time offset for Group 1 to be different than the time offset for Group 2 (e.g., n0_grp2). Alternatively, the time offset for Group 1 may be different than the time offset for Group 2 but the location of the Group 1 SS may be configured to overlap in time with the location of the Group 2 SS.

In some embodiments, if multiple TCI states are listed within the ControlResourceSet parameter structure, a new MAC CE may be introduced for Group 1 and/or Group 2 which may be referred to as “TCI state indication for Group (1/2) PDCCH MAC control element.” Thus, in addition to the MAC CE activation command, another MAC CE may be provided for the multiple TCI states.

In one example, a single MAC CE may be used for MSM and beam management. Each TCI state may be configured to include an indication of a corresponding Group 1 SS configuration (e.g., timing information, time offset (n0), slot group size (e.g., X, B), PDCCH monitoring span (e.g., Y, A), etc.).

In another example, a separate MAC CE may be used for MSM and beam management. One MAC CE may be used to provide a TCI state indication for the MSM offset. This exemplary MAC CE may include a field for the time offset (n0) for the Group 1 SS. In some examples, the MAC CE may also include fields for other Group 1 SS parameters, e.g., slot group size (e.g., X, B), PDCCH monitoring span (e.g., Y, A), etc.

In a further example, a single MAC CE may be used for both MSM and beam management using different states for the MSM and the beam management. In this example, each TCI state may be enhanced to include an indication of a corresponding location for a Group 1 SS via explicit or implicit signaling.

There may be scenarios in which DCI may be utilized in the examples provided above instead of a MAC CE. For instance, when Rel-17 unified TCI is configured, the TCI for CORESETs may be updated by DCI. In this scenario, the MAC CEs in the examples provided above may be replaced by DCI or a configuration corresponding to a TCI codepoint in DCI when TCI is present in the DCI.

In addition, there may be scenarios in which CORESETs without TCI indications are utilized (e.g., CORESET #0 QCL assumption after random access, CORESETs QCL assumption after beam failure recovery, etc.). In this type of scenario, a default value for the parameter may be used based on the SSB.

In another aspect, the exemplary embodiments relate to Group 2 SS set beam adaptation. However, prior to discussing these exemplary embodiments, additional details for Group 2 SS set configuration are provided below.

As mentioned above, a Group 2 SS set may refer to a type 0 CSS, a type 0A CSS, a type 1 CSS and/or a type 2 CSS. For type 0 CSS, the location of the Group 2 SS may be based on an associated SSB. For type 0A, type 1 without dedicated RRC configuration and type 2 CSS, the Group 2 SS may be located anywhere within a slot. However, with the use of MSM, type 0A, 1 without dedicated RRC configuration and 2 CSS may be configured by the gNB but are limited in their locations and may become beam specific. Thus, the location of the Group 2 SS may depend on the specific beam and the associated SSB. Examples of the Group 2 SS configuration for each of these types of CSS are provided below.

In some embodiments, to configure the corresponding SS sets for type 0A and type 1 without dedicated RRC configuration, the location may be limited within AGroup2 but may be any the OFDM symbols. In this example, the Group 2 SS set configuration may be a function of periodicity (e.g., a multiple of the slot group size (e.g., X, B)), a slot group offset which is equivalent to the time offset of the type 0 CSS, a SS set offset that is less than or equal to AGroup2, a duration (e.g., a number of multi-slot groups that the SS covers) and a monitoring symbols within a slot parameter that specifies a bit string that indicates the symbols within AGroup2 that the SS is located. The periodicity may be provided by the network using an exact number or the UE 110 may derive the periodicity by multiplying the legacy values by (X) or (B). In some embodiments, instead of a SS set offset parameter, a monitoring symbols within AGroup2 parameter may be utilized that specific a bit string that indicates the symbols within AGroup2 that the SS is located.

Alternatively, the location may be limited to the same slots that are used by type 0 CSS. In this example, the Group 2 SS set configuration may be a function of periodicity (e.g., a multiple of the slot group size (e.g., X, B)), a duration (e.g., a number of multi-slot groups that the SS covers) and monitoring symbols within AGroup2 parameter. In some embodiments, instead of the monitoring symbols within AGroup2 parameter, a monitoring symbols within type 0 CSS parameter may be utilized which specific a bit string that indicates the symbols within the type 0 CSS symbols that the SS is located. In another alternative embodiment, the location may share the same search space as CSS type 0.

For Group 2 SS set beam adaptation based on a change of CSS type 0, in some embodiments, the configuration of CSS type 0A/1/2 may be identical to the new CSS type 0 location. In other embodiments, a reconfiguration of CSS type 0A/1 without dedicated RRC configuration/2 may be required. In a further embodiment, the gNB may define multiple CSS type 0A/1 without dedicated RRC configuration/2 configurations and use MAC CE activation to identify the updated CSS type 0A/1 without dedicated RRC configuration/2 configuration that is to be utilized by the UE 110. In another embodiments, the configuration of CSS type 0A/1 without dedicated RRC configuration/2 may be configured using DCI based signaling.

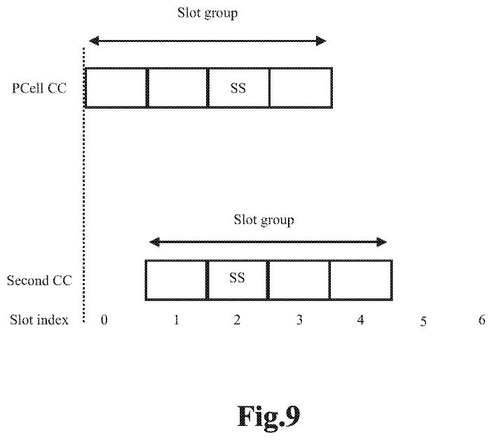

In another aspect, the exemplary embodiments relate to slot group alignment for CA. In the following examples, it may be assumed that the component carriers (CCs) are configured with the same SCS. In one example, there may not be an offset between the CCs. Thus, a first CC and a second different CC may be configured with a same slot group size (X) and time offset (n0). In another example, an offset between the CCs may be configured relative to the slot group the primary cell (PCell). The location of the slot group in the other CCs is shifted based on the offset and the SS sets between CCs are configured to align. An example of this is shown in FIG. 9 where the offset between CCs is 1 slot, the PCell CC may be configured with a slot group comprising slots indexed 0-3 and a second CC (e.g., secondary cell (SCell) or any other appropriate source of a second different CC) is configured with a slot group comprising slots indexed 1-4. However, the SS for second CC is configured within slot index 2 based on the offset to ensure alignment of with the SS for the PCell CC. In a further example, there may be no slot group alignment restrictions.

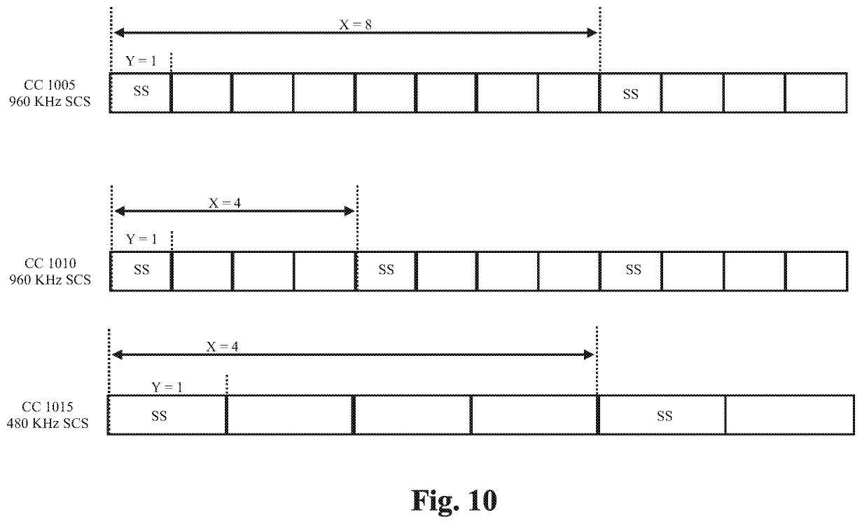

In the following example, it may be assumed that CCs are configured with different SCS. In one example, there may be no offsets between CCs. Thus, the slot group size (X) and the time offset (n0) may be different for each SCS and configured to align the SS sets between CCs. An example of this is shown in FIG. 10 where a first CC 1005 is configured with a 960 KHz SCS, a slot group size (X=8) slots and a SS size (Y=1) slot. A second CC 1010 is configured with 960 KHz SCS, a slot group size (x=4) slots and a SS size (Y=1) slot. A third CC 1015 is configured with a 480 KHz SCS, a slot group size (X=4) slots and a SS size (Y=1) slot.

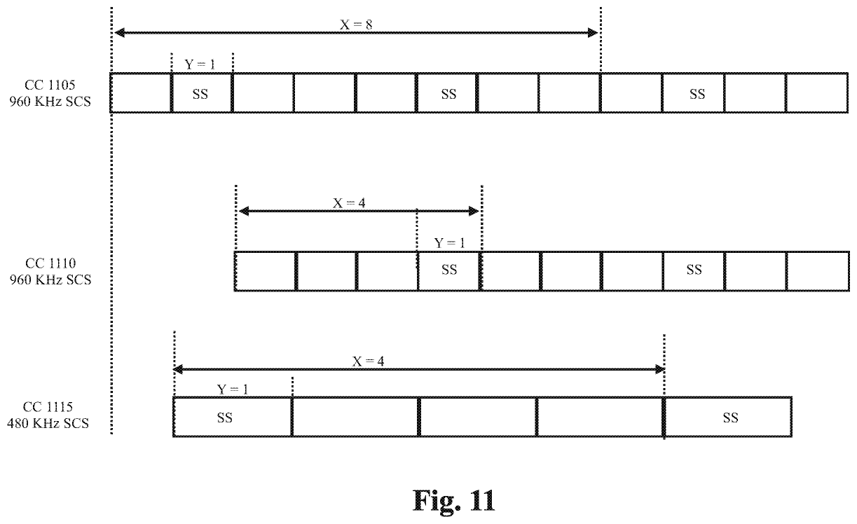

In another example, there may be an offset between CCs relative to the slot group of the CC with the smallest SCS (or largest duration). Generally, this CC may correspond to the cell with the smallest servingCellIndex and the smallest SCS. The location of the slot groups in the other CCs may be shifted based on the offset but configured to align SSs in the different CCs. An example of this is shown in FIG. 11 where a first CC 1105 is configured with a 960 KHz SCS, a slot group size (X=8) slots and a SS size (Y=1) slot. A second CC 1110 is configured with 960 KHz SCS, a slot group size (x=4) slots and a SS size (Y=1) slot. A third CC 1115 is configured with a 480 KHz SCS, a slot group size (X=4) slots and a SS size (Y=1) slot. In this example, the SSs for each CC are configured to align based on the third CC 1115 because it is the smallest SCS of the three CCs 1105-1115.

In a further example, there may be no slot group alignment restrictions for Group 2 while alignment restrictions are kept for Group1. In this case, although Group 1 SS sets are located in a manner suitable for UE implementation, it is possible that there may be some overlap or proximity between the Group 1 SS sets and Group 2 SS sets. For instance, consider a scenario in which YGroup1 and YGroup2 are both located within the same slot of a subframe (e.g., slot index 0). For any of a variety of different reasons, it may be beneficial to limit the number of SSs within a same slot or separated by less than a predetermined number of slots (e.g., 1 slot, 2 slots, 3 slots, etc.). Thus, to prevent these types of scenarios, the UE 110 may drop Group 1 SS located in a slot with Group 2 SS and/or located less than a number of slots away from the Group 2 SS. The number of slots may be predetermined/specified, may be based on the UE capability or on a gNB configuration.

FIG. 12 shows an exemplary network arrangement 1200 according to various exemplary embodiments. The exemplary network arrangement 1200 includes the UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 1200, the network with which the UE 110 may wirelessly communicate is a 5G NR radio access network (RAN) 1220. However, the UE 110 may also communicate with other types of networks (e.g., 5G cloud RAN, a next generation RAN (NG-RAN), a long-term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 1220. Therefore, the UE 110 may have a 5G NR chipset to communicate with the 5G NR RAN 1220.

The 5G NR RAN 1220 may be a portion of a cellular network that may be deployed by a network carrier (e.g., Verizon, AT&T, T-Mobile, etc.). The 5G NR RAN 1220 may include, for example, nodes, cells or base stations (e.g., Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 110 to connect to the 5G NR-RAN 1220. For example, as discussed above, the 5G NR-RAN 1220 may be associated with a particular cellular provider where the UE 110 and/or the user thereof has a contract and credential information (e.g., stored on a SIM card). Upon detecting the presence of the 5G NR-RAN 1220, the UE 110 may transmit the corresponding credential information to associate with the 5G NR-RAN 1220. More specifically, the UE 110 may associate with a specific base station, e.g., the next generation Node B (gNB) 1220A.

The network arrangement 1200 also includes a cellular core network 1230, the Internet 1240, an IP Multimedia Subsystem (IMS) 1250, and a network services backbone 1260. The cellular core network 1230 may refer an interconnected set of components that manages the operation and traffic of the cellular network. It may include the evolved packet core (EPC) and/or the fifth generation core (5GC). The cellular core network 1230 also manages the traffic that flows between the cellular network and the Internet 1240. The IMS 1250 may be generally described as an architecture for delivering multimedia services to the UE 110 using the IP protocol. The IMS 1250 may communicate with the cellular core network 1230 and the Internet 1240 to provide the multimedia services to the UE 110. The network services backbone 1260 is in communication either directly or indirectly with the Internet 1240 and the cellular core network 1230. The network services backbone 1260 may be generally described as a set of components (e.g., servers, network storage arrangements, etc.) that implement a suite of services that may be used to extend the functionalities of the UE 110 in communication with the various networks.

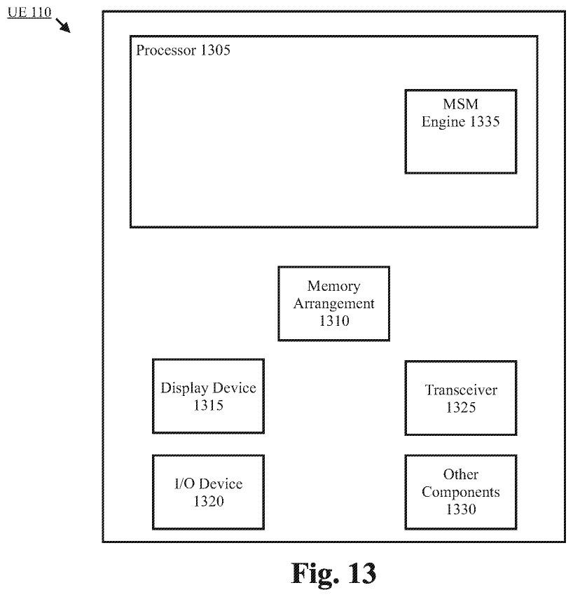

FIG. 13 shows an exemplary UE 110 according to various exemplary embodiments. The UE 110 will be described with regard to the network arrangement 1200 of FIG. 12. The UE 110 may include a processor 1305, a memory arrangement 1310, a display device 1315, an input/output (I/O) device 1320, a transceiver 1325 and other components 1330. The other components 1330 may include, for example, an audio input device, an audio output device, a power supply, a data acquisition device, ports to electrically connect the UE 110 to other electronic devices, etc.

The processor 1305 may be configured to execute a plurality of engines of the UE 110. For example, the engines may include a MSM engine 1335. The MSM engine 1335 may perform various operations related to the exemplary techniques described above including, but not limited to, receiving MSM parameters, identifying a time offset for Group 1 SS set (e.g., YGroup1), identifying a time offset for Group 2 SS set (e.g., AGroup2), Group 1 SS beam adaptation and Group 2 SS beam adaptation.

The above referenced engine 1335 being an application (e.g., a program) executed by the processor 1305 is merely provided for illustrative purposes. The functionality associated with the engine 1335 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 1305 is split among two or more processors such as a baseband processor and an applications processor. The exemplary embodiments may be implemented in any of these or other configurations of a UE.

The memory arrangement 1310 may be a hardware component configured to store data related to operations performed by the UE 110. The display device 1315 may be a hardware component configured to show data to a user while the I/O device 1320 may be a hardware component that enables the user to enter inputs. The display device 1315 and the I/O device 1320 may be separate components or integrated together such as a touchscreen. The transceiver 1325 may be a hardware component configured to establish a connection with the 5G NR-RAN 1220, an LTE-RAN (not pictured), a legacy RAN (not pictured), a WLAN (not pictured), etc. Accordingly, the transceiver 1325 may operate on a variety of different frequencies or channels (e.g., set of consecutive frequencies).

FIG. 14 shows an exemplary base station 1400 according to various exemplary embodiments. The base station 1400 may represent the gNB 1220A or any other access node through which the UE 110 may establish a connection and manage network operations.

The base station 1400 may include a processor 1405, a memory arrangement 1410, an input/output (I/O) device 1415, a transceiver 1420, and other components 1425. The other components 1425 may include, for example, an audio input device, an audio output device, a battery, a data acquisition device, ports to electrically connect the base station 1400 to other electronic devices, etc.

The processor 1405 may be configured to execute a plurality of engines for the base station 1400. For example, the engines may include a MSM engine 1430. The MSM engine 1430 may perform various operations related to the UE 110 performing MSM including, but not limited to, signaling MSM parameters to the UE 110, signaling a beam change and scheduling PDCCH resources for the UE 110.

The above noted engine 1430 being an application (e.g., a program) executed by the processor 1405 is only exemplary. The functionality associated with the engine 1430 may also be represented as a separate incorporated component of the base station 1400 or may be a modular component coupled to the base station 1400, e.g., an integrated circuit with or without firmware. For example, the integrated circuit may include input circuitry to receive signals and processing circuitry to process the signals and other information. In addition, in some base stations, the functionality described for the processor 1405 is split among a plurality of processors (e.g., a baseband processor, an applications processor, etc.). The exemplary embodiments may be implemented in any of these or other configurations of a base station.

The memory 1410 may be a hardware component configured to store data related to operations performed by the base station 1400. The I/O device 1415 may be a hardware component or ports that enable a user to interact with the base station 1400. The transceiver 1420 may be a hardware component configured to exchange data with the UE 110 and any other UE in the network arrangement 1200. The transceiver 1420 may operate on a variety of different frequencies or channels (e.g., set of consecutive frequencies). Therefore, the transceiver 1420 may include one or more components (e.g., radios) to enable the data exchange with the various networks and UEs.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor configured to:
configure a first search space (SS) set of a first slot group for multi-slot physical downlink control channel (PDCCH) monitoring (MSM);
configure a second SS set of a second slot group for MSM;
process, based on signals received from a network, an indication of a beam change in a control resource set (CORESET);
configure an updated first SS set of the first slot group for MSM;
configure an updated second SS set of the second slot group for MSM; and
perform MSM using the updated first SS set and the updated second SS set.

2. The processor of claim 1, further configured to:
process, based on signals received from the network, a medium access control (MAC) control element (CE), the MAC CE indicating a slot group size, a span of PDCCH within a slot group and a time offset parameter relative to the slot group size, wherein configuring the updated first SS set for MSM is based on the MAC CE.

3. (canceled)

4. The processor of claim 1, wherein configuring the updated first SS set is based on a time offset parameter relative to a slot group size, wherein the time offset parameter is indicated by a transmission configuration indicator (TCI) state based on an initial access synchronization signal block (SSB).

5. The processor of claim 1, wherein configuring the updated first SS set is performed prior to configuring the updated second SS set, wherein the updated second SS set is based on the updated first SS set.

6. The processor of claim 1, wherein configuring the updated first SS set is based on a MSM state associated with a transmission configuration indicator (TCI) state.

7. The processor of claim 1, wherein configuring the updated first SS set is based on radio resource control (RRC) signaling.

8. The processor of claim 1, wherein configuring the updated first SS set is based on a common search space (CSS) type 0 configuration.

9-10. (canceled)

11. The processor of claim 1, wherein configuring the updated first SS set is performed without an initial access procedure.

12. The processor of claim 11, the operations further comprising configured to:
receiving process, based on signals received from the network, one or more radio resource control (RRC) signals comprising one or more parameters, wherein the updated second SS set is based on the one or more parameters.

13. The processor of claim 11, further configured to:
process, based on signals received from the network, a medium access control (MAC) control element (CE) activation command indicating a location to be used for the updated second SS set,
wherein the UE receives a radio resource control (RRC) configuration of a transmission configuration indicator (TCI) state indication for the updated second SS set.

14. (canceled)

15. The processor of claim 13, wherein the TCI state is associated with a synchronization signal block (SSB) or a channel state information (CSI)-reference signal (RS).

16-20. (canceled)

21. The processor of claim 1, wherein configuring the updated first SS set comprises setting one or more of a common search space (CSS) type 0A, CSS type 1 and CSS type 2 to be identical to a new CSS type 0 location.

22. The processor of claim 1, wherein configuring the updated first SS set comprises setting a new common search space (CSS) type 0 location and updating one or more of a CSS type 0A, CSS type 1 and CSS type 2 configuration identified by a medium access control (MAC) control element (CE) activation.

23. The processor of claim 1, wherein configuring the updated first SS set comprises setting a new common search space (CSS) type 0 location and updating one or more of a CSS type 0A, CSS type 1 and CSS type 2 configuration identified by downlink control information (DCI).

24. The processor of claim 1, wherein configuring an updated second SS set for MSM comprises identifying a second slot group time offset parameter relative to a slot group size.

25-27. (canceled)

28. A processor of a base station configured to perform operations comprising:
transmitting multi-slot physical downlink control channel (PDCCH) monitoring (MSM) parameters to a user equipment (UE), wherein the UE utilizes multiple slot groups to perform MSM; and
transmitting information to the UE on the PDCCH.

29. The processor of claim 28, wherein the multiple slot groups include a first slot group corresponding to a first search space (SS) set comprising at least one of a type 1 common search space (CSS) with a dedicated radio resource control (RRC) configuration, a type 3 CC and a UE specific SS.

30. (canceled)

31. The processor of claim 28, wherein the MSM parameters comprise a slot group size, a span of PDCCH to be monitored within a slot group and a time offset relative to the slot group size.

32. The processor of claim 28, wherein the MSM parameters comprise a slot group size and wherein a span of PDCCH to be monitored within a slot group and a time offset relative to the slot group size are implicitly provided to the UE.

33. The processor of claim 28, wherein the MSM parameters comprise a slot group size and a time offset relative to the slot group size and wherein a span of PDCCH to be monitored within a slot group is implicitly provided to the UE.
